(19) United States
(12) Patent Application Publication
(10) Pub. No.: US 2003/0034623 A1
(43) Pub. Date: Feb. 20, 2003

(54) Trunnion assembly for an oscillating axle

(76) Inventors: Gregory T. DeWald, Mooresville, NC (US); Tony E. Dalton, Statesville, NC (US)

Correspondence Address: DYKEMA GOSSETT PLLC, Suite 300, 39577 Woodward Avenue, Bloomfield Hills, MI, 48304, US

(21) Appl. No.: 09/929,972

(22) Filed: Aug. 15, 2001

(51) Int. Cl. B60G 1/00

(52) U.S. Cl. 280/124.11

(57) ABSTRACT

A trunnion assembly for an oscillating axle, pivotable about an axis, is provided. The trunnion assembly includes a trunnion that is mounted to the axle housing and is disposed about the pivot axis of the axle. The trunnion has first and second axial ends and includes a recess disposed between the two ends. The recess is configured to receive a seal used to retain lubricants. The location of the recess limits exposure of the seal to foreign objects and elements thereby prolonging the life of the seal and related components of the trunnion assembly.

### BACKGROUND OF THE INVENTION

1. Field of the Invention

This invention relates to oscillating axles and, in particular, to a trunnion assembly for an oscillating axle.

2. Disclosure of Related Art

A conventional oscillating axle assembly includes an axle housing extending along a longitudinal axis and enclosing a differential. One or more vehicle wheels may be disposed at either longitudinal end of the axle. The axle assembly further includes trunnions that are pivotably mounted to the forward and rear (relative to the direction of vehicle travel) of the axle housing either on the housing itself or on brackets that are coupled to the housing. The trunnions couple the axle to the vehicle frame and allow rotational movement of the axle about a longitudinal axis of the vehicle.

In many conventional oscillating axle assemblies, the axle housing is capable of fore-aft movement relative to both of the trunnions along the longitudinal axis of the vehicle. In these assemblies, variations in mounting position within vehicles often results in undesirably high degrees of fore-aft movement by the axle relative to the vehicle frame. As a result, some oscillating axle assemblies attempt to limit or eliminate fore-aft movement of the axle relative to at least one of the trunnions. In most conventional assemblies, this has been accomplished by using shims to limit fore-aft movement between the axle housing and one of the trunnions. The use of shims, however, is undesirable because of the increase in time required to measure and accurately select the appropriate size for each vehicle frame. U.S. Pat. No. 3,811,699 discloses an oscillating axle assembly in which fore-aft movement of the axle is controlled by locating one of the trunnions between a pair of thrust washers which are in turn disposed between the axle housing and one end of a mounting bracket coupled to the housing. The disclosed oscillating axle assembly, however, suffers from several drawbacks. First, the assembly exposes to foreign elements and objects several seals that are used to protect bushings or bearings from exposure to contaminants. As a result, the seals can become damaged. Second, the assembly requires a relatively high number of parts in order to limit fore-aft movement between the axle and the trunnion.

There is thus a need for an oscillating axle assembly that will minimize or eliminate one or more of the above-mentioned deficiencies.

### SUMMARY OF THE INVENTION

The present invention provides an oscillating axle assembly and, in particular, a trunnion assembly for an oscillating axle assembly.

A trunnion assembly for an oscillating axle assembly pivotable about an axis in accordance with the present invention includes a trunnion coupled to an axle housing of the oscillating axle. The trunnion is disposed about the pivoting axis of the axle and includes first and second axial ends. The trunnion assembly further includes a seal. The trunnion includes a recess configured to receive the seal and the recess is located between the first and second axial ends of the trunnion.

An oscillating axle assembly in accordance with the present invention includes an axle housing that is pivotable about an axis. The assembly also includes a first trunnion coupled to the axle housing and disposed about the axis. The first trunnion is movable relative to the axle housing along the axis and has first and second axial ends. The assembly also includes a trunnion bracket having a body portion and a flange portion. The body portion is coupled to the axle housing at a first end and defines a first shoulder with the axle housing. The flange portion is coupled to a second end of the body portion and defines a second shoulder opposing the first shoulder. The assembly further includes a second trunnion supported on the trunnion bracket and disposed about the axis. The second trunnion has first and second axial ends and a portion of the trunnion is received between the first and second shoulders to thereby limit movement of the second trunnion relative to the axle housing along the axis. Finally, the assembly includes first, second, third, and fourth seals. The first trunnion defines first and second recesses in which the first and second seals are disposed. The first and second recesses of said first trunnion are located between said first and second axial ends of said first trunnion. Similarly, the second trunnion defines first and second recesses in which the third and fourth seals are disposed. The first and second recesses of the second trunnion are located between the first and second axial ends of the second trunnion.

An oscillating axle assembly in accordance with the present invention represents a significant improvement as compared to conventional assemblies. The trunnions in the inventive trunnion assemblies locate the seals between the axial ends of the trunnions in closed recesses. As a result, the seals have limited exposure to foreign objects and elements and are less likely to be damaged. The inventive assembly also uses fewer parts than conventional assemblies. As a result, the inventive assembly achieves savings in cost, manufacture and assembly time, and vehicle weight.

These and other features and objects of this invention will become apparent to one skilled in the art from the following detailed description and the accompanying drawings illustrating features of this invention by way of example.

### BRIEF DESCRIPTION OF THE DRAWINGS

FIG. 1 is a top and partial sectional view of an oscillating axle assembly in accordance with the present invention with a portion of the axle housing cut away.

FIG. 2 is a partial sectional view of the forward trunnion assembly of the oscillating axle assembly of FIG. 1.

FIG. 3 is a partial sectional view of the rear trunnion assembly of the oscillating axle assembly of FIG. 1.

### DETAILED DESCRIPTION OF THE PREFERRED EMBODIMENT

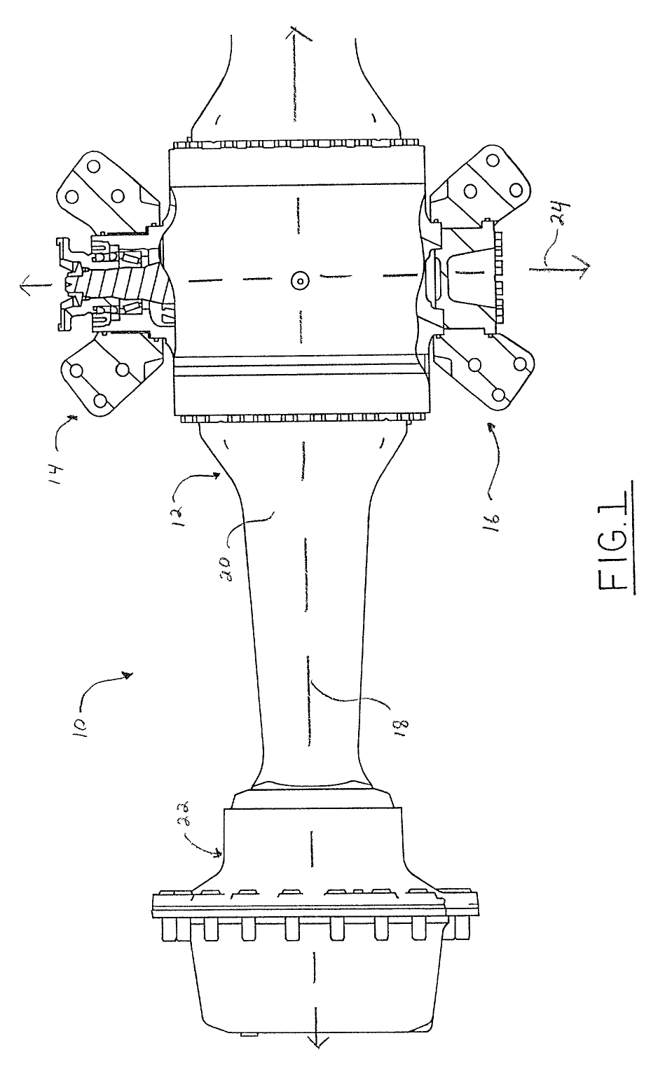

Referring now to the drawings wherein like reference numerals are used to identify identical components in the various views, FIG. 1 illustrates an oscillating axle assembly 10 in accordance with the present invention. Assembly 10 is configured for use in an off-highway vehicle. It should be understood, however, that the invention described herein may find application in a wide variety of vehicles. Assembly 10 may include an axle 12 and forward and rear trunnion assemblies 14, 16.

Axle 12 is provided to support a vehicle frame (not shown) on wheels (not shown) disposed proximate either end of axle 12. Axle 12 is disposed about a longitudinal axis 18 and may include an axle housing 20 and wheel hub assemblies 22 disposed at either axial end of housing 20. Axle 12 is pivotable about a longitudinal axis 24 of the vehicle extending through axle 12 perpendicular to axis 18.

Axle housing 20 provides structural support for the other components of axle 12 and houses the axle shafts (not shown) and wheel differential (not shown). Housing 20 is conventional in the art any may be made from conventional metals and metal alloys such as steel by forging or fabrication. Housing 20 is disposed about both axis 18 and axis 24. It should be understood that the size, shape, and configuration of axle housing 20 may be varied without departing from the spirit of the present invention. In particular, the size, shape, and configuration of housing 20 will often vary in accordance with design requirements associated with other components of the vehicle including, for example, the frame, differential, and suspension.

Hub assemblies 22 are provided to support wheels (not shown) and brake assemblies (not shown) and are conventional in the art. Hub assemblies 22 may be made integral with axle housing 20 or may be coupled to housing 20. Although only one hub assembly 22 is shown in the illustrated embodiment, it should be understood that a corresponding hub assembly 22 will be disposed at an opposite end of axle 12.

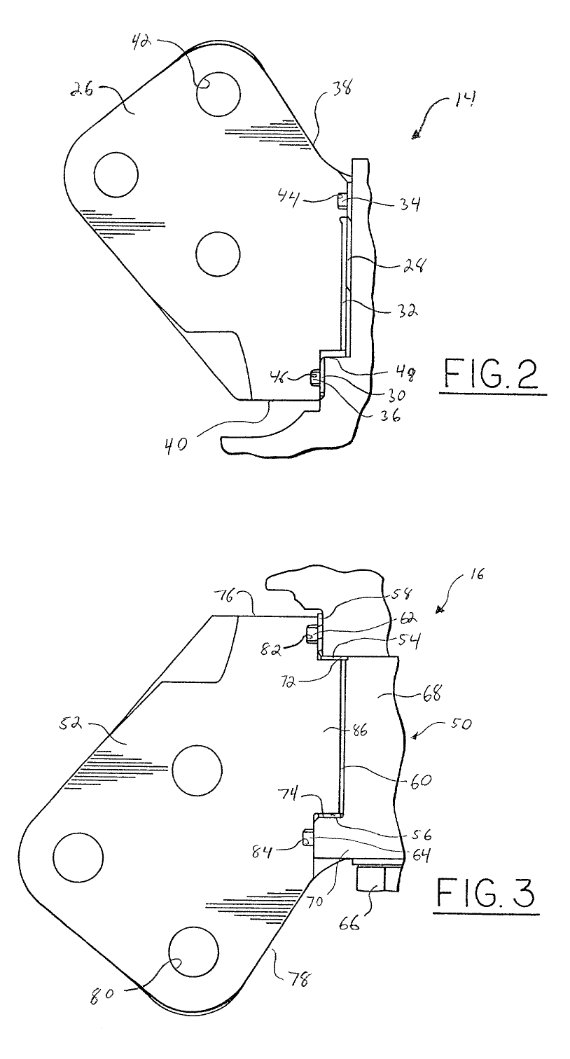

Referring now to FIG. 2, forward trunnion assembly 14 will be described in greater detail. Assembly 14 is provided to couple axle 12 to the vehicle frame, but allow axle 12 to pivot about axis 24. Assembly 14 is disposed on a first, forward side of axis 18 of axle 12 and is disposed about axis 24. Assembly 14 may include a trunnion 26, wear sleeves 28, 30, a bushing 32 and seals 34, 36.

Trunnion 26 is provided to couple axle 12 to the vehicle frame and allow relative rotation of axle 12. Trunnion 26 is further designed to allow movement of axle 12 relative to the vehicle frame in a fore-aft direction (i.e., the longitudinal direction of the vehicle) in order to account for variations in vehicle frame mountings. Trunnion 26 may be made from conventional metals and metal alloys such as steel. Trunnion 26 is disposed on a forward end of axle housing 20. Trunnion 26 may be disposed about axis 24 and includes first and second axial ends 38, 40. In the illustrated embodiment, trunnion 26 has a shape somewhat similar to a large wing nut (see FIG. 1) with a pair of generally square or rectangular wings extending outwardly from a cylindrical portion disposed about the forward end of housing 20 and extending at an angle relative to axis 24. Each of these wings may include one or more apertures 42 configured to receive fasteners to thereby couple trunnion 26 to the vehicle frame. It should be understood, however, that the size, shape, and configuration of trunnion 26 may be varied without departing from the spirit of the present invention. In accordance with the present invention, trunnion 26 includes recesses 44, 46 configured to receive seals 34, 36. Recesses 44, 46 may be annular in shape. Recesses 44, 46 may be disposed proximate either axial end 38, 40 of trunnion 26 on either side of bushing 32. Recesses 44, 46, however, are disposed between ends 38, 40 of trunnion 26 in accordance with the present invention in order to limit exposure of seals 34, 36 to foreign objects and elements. Trunnion 26 may further include an inlet (not shown) through which a lubricant may be provided to bushing 32 between seals 34, 36.

Wear sleeves 28, 30 provide a hardened surface upon which bushing 32 and seals 34, 36 may rotate relative to axle housing 20. Sleeves 28, 30 are conventional in the art. In the illustrated embodiment, assembly includes two wear sleeves 28, 30 in view of the configuration of axle housing 20. It should be understood, however, that the number of wear sleeves may vary responsive to the configuration of axle housing 20 and other components of assembly 10 and a single wear sleeve (or even no wear sleeves) may be sufficient depending upon this configuration. Sleeves 28, 30 are disposed about housing 20 and axis 24 and may be generally cylindrical or annular in shape. Sleeve 28 extends on housing 20 from a point at or near end 38 of trunnion 26 to a shoulder 48 defined in housing 20. Sleeve 30 extends from shoulder 48 to a point at or near end 40 of trunnion 26. Sleeve 28 extends across recess 44 in trunnion 26 thereby closing recess 44. Similarly, sleeve 30 extends across recess 46 thereby closing recess 46.

Bushing 32 is provided to allow relative rotation between trunnion 26 and axle housing 20 under radial loads and is conventional in the art. Although a bushing 32 is used in the illustrated embodiment, it should be understood that bearings or equivalent devices for allowing relative rotation may alternatively be used. Bushing 32 is disposed about axis 24 on the forward end of axle housing 20. Bushing 32 may be annular in shape and is disposed between axle housing 20 and trunnion 26, radially outwardly of wear sleeve 28.

Seals 34, 36 are provided to protect bushing 32 from exposure to foreign elements and objects and to retain lubricants. Seals 34, 36 are conventional in the art. Seals 34, 36 are disposed about the forward end of axle housing 20 and about axis 24 and may be generally annular in shape. The diameter of each seal 34, 36 may be sized relative to axle housing 20 (or, as in the illustrated embodiment, relative to wear sleeves 28, 30). Seals 34, 36 are disposed within recesses 44, 46 formed in trunnion 26.

Referring now to FIG. 3, rear trunnion assembly 16 will be described in greater detail. Assembly 16 is provided to couple axle 12 to the vehicle frame, but allow axle 12 to pivot about axis 24. Assembly 16 is disposed on a second, rearward side of axis 18 of axle 12 and is disposed about axis 24. Assembly 16 may include a trunnion bracket 50, a trunnion 52, thrust washers 54, 56, a wear sleeve 58, a bushing 60 and seals 62, 64.

Trunnion bracket 50 is provided to mount trunnion 52 to axle housing 20. Bracket 50 may be coupled to housing 20 on a rearward side of housing 20 using one or more fasteners 66. Alternatively, bracket 50 may be coupled to housing 20 by welds or in other ways conventional in the art. Bracket 50 may include a body portion 68 and a flange portion 70 that are generally circular in shape and may be disposed about axis 24 upon assembly to housing 20. Body portion 68 may be coupled to housing 20 at a first end and may define a shoulder 72 with housing 20. Flange portion 70 may be coupled to the opposite end of body portion 68 and may define a shoulder 74 opposing shoulder 72. In accordance with one advantage of the present invention, bracket 50 is unitary in construction with flange portion 70 being integral with body portion 68 to thereby reduce the number of components in assembly 10.

Trunnion 52 is provided to couple axle 12 to the vehicle frame and allows relative rotation of axle 12 while supporting axle thrust loads in both directions along axis 24. Trunnion 52 may be made from conventional metals and metal alloys such as steel. Trunnion 52 is disposed on a rearward end of axle housing 20 about axis 24 and includes first and second axial ends 76, 78. Like trunnion 26, in the illustrated embodiment trunnion 52 has a shape somewhat similar to a large wing nut (see FIG. 1) with a pair of generally square or rectangular wings extending outwardly from a cylindrical portion disposed about housing 20 and extending at an angle relative to axis 24. Each of these wings may include one or more apertures 80 configured to receive fasteners to thereby couple trunnion 52 to the vehicle frame. It should be understood, however, that the size, shape, and configuration of trunnion 52 may be varied without departing from the spirit of the present invention. In accordance with the present invention, trunnion 52 includes recesses 82, 84 configured to receive seals 62, 64. Recesses 82, 84 may be annular in shape. Recesses 82, 84 may be disposed proximate either end 76, 78 of trunnion 52 on either side of bushing 60. Recesses 82, 84, however, are disposed between ends 76, 78 of trunnion 52 in accordance with the present invention in order to limit exposure of seals 62, 64 to foreign objects and elements. Trunnion 52 may further include an inlet (not shown) through which a lubricant may be provided to bushing 60 between seals 62, 64. A portion 86 of trunnion 52 extends radially inwardly and is received between shoulders 72, 74 thereby limiting movement of trunnion 52 along axis 24.

Thrust washers 54, 56 are provided to allow relative rotation of trunnion 52 and axle housing 20 while supporting axle thrust loads in the fore-aft direction. Washers 54, 56 are conventional in the art and may be made from conventional metals and metal alloys such as steel plated with zinc. A non-friction lining may be laminated to the plated steel. Washers 54, 56 may be annular in shape and may be disposed about trunnion bracket 50 and axis 24. Washer 54 is disposed between shoulder 72 and portion 86 of trunnion 52 while washer 56 is disposed between shoulder 74 and portion 86 of trunnion 52. The dimensions of washers 54, 56, together with bracket 50 and trunnion 52 determine the size of the axial gap between shoulders 72, 74 of bracket 50 and, therefore, the amount of fore-aft movement available to axle 12 relative to the vehicle frame.

Wear sleeve 58 provides a hardened surface upon which seal 82 may rotate relative to axle housing 20. Sleeve 58 is conventional in the art. As with trunnion assembly 14, wear sleeve 58 of assembly 16 may be omitted depending upon the design of axle 12 and trunnion assembly 16. Sleeve 58 is disposed about housing 20 and axis 24 and may be generally cylindrical or annular in shape. Sleeve 58 extends on housing 20 from a point at or near end 76 of trunnion 52 to shoulder 72. Sleeve 58 extends across recess 82 thereby closing recess 82. Recess 84 of trunnion 52 is closed by flange portion 70 of bracket 50.

Bushing 60 is provided to allow relative rotation between trunnion 52 and axle housing 20 under radial loads and is conventional in the art. Although a bushing 60 is used in the illustrated embodiment, it should again be understood that bearings or equivalent devices for allowing relative rotation may alternatively be used. Bushing 60 is disposed about axis 24 on trunnion bracket 50 between shoulders 72, 74. Bushing may be annular in shape and is disposed between trunnion 52 and trunnion bracket 50.

Seals 62, 64 are provided to protect bushing 60 from exposure to foreign elements and objects and to retain lubricants. Seals 62, 64 are conventional in the art. Seals 62, 64 are disposed about the rearward end of axle housing 20 and about axis 24 and may be generally annular in shape. The diameter of each seal 62, 64 may be sized relative to axle housing 20 (or, in the illustrated embodiment, relative to wear sleeve 58). Seals 62, 64 are disposed within recesses 82, 84 formed in trunnion 52.

A oscillating axle assembly 10 in accordance with the present invention and, in particular, a trunnion assembly 14 or 16 for such an axle assembly, represents a significant improvement as compared to conventional assemblies. By locating the seals 34, 36 and 62, 64 within recesses 44, 46 and 82, 84, respectively, formed in the trunnions 26, 52 between the axial ends 38, 40 and 76, 78 of the trunnions 26, 52, the seals 34, 36 and 62, 64 have only limited exposure to foreign elements and objects. As a result, the seals 34, 36 and 62, 64 and other components of the trunnion assemblies 14, 16 have a much longer lifespan. The inventive assembly 10 also requires fewer parts as compared to conventional assemblies thereby reducing cost, manufacturing and assembly time, and vehicle weight.

While the invention has been particularly shown and described with reference to the preferred embodiments thereof, it is well understood by those skilled in the art that various changes and modifications can be made in the invention without departing from the spirit and scope of the invention.

We claim:

1. A trunnion assembly for an oscillating axle assembly pivotable about an axis, comprising:
a trunnion coupled to an axle housing of said oscillating axle assembly and disposed about said axis, said trunnion having first and second axial ends; and,
a first seal
wherein said trunnion includes a first recess configured to receive said first seal, said first recess located between said first and second axial ends of said trunnion.

2. The trunnion assembly of claim 1, further comprising a bushing disposed between said axle housing and said trunnion.

3. The trunnion assembly of claim 1, further comprising a wear sleeve disposed between said axle housing and said trunnion.

4. The trunnion assembly of claim 3 wherein said wear sleeve closes said first recess.

5. The trunnion assembly of claim 1, further comprising a second seal wherein said trunnion includes a second recess configured to receive said second seal, said second recess located between said first and second axial ends of said trunnion.

6. The trunnion assembly of claim 1, further comprising a trunnion bracket having:
a body portion coupled to said axle housing at a first end and defining a first shoulder with said axle housing; and,
a flange portion coupled to a second end of said body portion and defining a second shoulder opposing said first shoulder.

7. The trunnion assembly of claim 6 wherein said flange portion is integral with said body portion.

8. The trunnion assembly of claim 6 wherein a portion of said trunnion is received between said first and second shoulders.

9. The trunnion assembly of claim 8, further comprising:
a first thrust washer disposed between said first shoulder and said portion of said trunnion; and,
a second thrust washer disposed between said second shoulder and said portion of said trunnion.

10. The trunnion assembly of claim 6, further comprising a bushing disposed about said trunnion bracket between said first and second shoulders.

11. An oscillating axle assembly, comprising:
an axle housing pivotable about an axis;
a first trunnion coupled to said axle housing and disposed about said axis, said first trunnion movable relative to said axle housing along said axis and having first and second axial ends;
a trunnion bracket having
a body portion coupled to said axle housing at a first end and defining a first shoulder with said axle housing; and,
a flange portion coupled to a second end of said body portion and defining a second shoulder opposing said first shoulder;
a second trunnion supported on said trunnion bracket and disposed about said axis, said second trunnion having first and second axial ends, a portion of said trunnion received between said first and second shoulders thereby limiting movement of said second trunnion relative to said axle housing along said axis; and,
first, second, third, and fourth seals;
wherein said first trunnion defines first and second recesses in which said first and second seals are disposed, said first and second recesses of said first trunnion located between said first and second axial ends of said first trunnion and said second trunnion defines first and second recesses in which said third and fourth seals are disposed, said first and second recesses of said second trunnion located between said first and second axial ends of said second trunnion.

12. The oscillating axle assembly of claim 11, further comprising a bushing disposed between said axle housing and said trunnion.

13. The oscillating axle assembly of claim 12 wherein said first trunnion is configured to receive said bushing between said first and second recesses of said first trunnion.

14. The oscillating axle assembly of claim 11, further comprising a bushing disposed about said trunnion bracket between said first and second shoulders.

15. The oscillating axle assembly of claim 14 wherein said second trunnion is configured to receive said bushing between said first and second recesses of said second trunnion.

16. The oscillating axle assembly of claim 11, further comprising a wear sleeve disposed between said axle housing and said first trunnion.

17. The oscillating axle assembly of claim 16 wherein said wear sleeve closes said first recess.

18. The oscillating axle assembly of claim 11 wherein said flange portion of said trunnion bracket is integral with said body portion of said trunnion bracket.

19. The oscillating axle assembly of claim 11, further comprising:
a first thrust washer disposed between said first shoulder and said portion of said second trunnion; and,
a second thrust washer disposed between said second shoulder and said portion of said second trunnion.
